(19) United States
(12) Patent Application Publication
(10) Pub. No.: US 2015/0116204 A1
(43) Pub. Date: Apr. 30, 2015

(54) TRANSPARENT DISPLAY VIRTUAL TOUCH APPARATUS NOT DISPLAYING POINTER

(71) Applicant: VTouch Co., Ltd., Seoul (KR)

(72) Inventor: Seok-Joong Kim, Seoul (KR)

(73) Assignee: VTouch Co., Ltd., Songpa-gu, Seoul (KR)

(21) Appl. No.: 14/396,385

(22) PCT Filed: Apr. 22, 2013
(86) PCT No.: PCT/KR2013/003421

§ 371 Date: Oct. 23, 2014

(30) Foreign Application Priority Data
Apr. 23, 2012 (KR) 10-2012-0041985

(51) Int. Cl. G06F 3/01

(52) U.S. Cl. CPC G06F 3/013; G06F 3/017
USPC 345/156

(57) ABSTRACT

The present invention is to provide a transparent display virtual touch apparatus capable of exquisitely operating by a display portion worn on a user's face and located in front of an eye of a user and of identifying contents regardless of the direction and location of the user. The present invention includes a transparent display portion, worn on a user's face and located in front of an eye of a user, for displaying contents on a display, a first image obtaining portion, attached to one side of the transparent display portion, for capturing a location for the eye of the user, a second image obtaining portion, attached to one side of the transparent display portion, for capturing the body of the user, and a virtual touch processing portion for detecting first space coordinates and second space coordinates using each calculated 3D coordinates data using images captured by the first image obtaining portion and the second image obtaining portion and for calculating contact point coordinates data for a display surface on the transparent display portion met by a line connecting the first space coordinates and second space coordinates.

### TECHNICAL FIELD

The present invention relates to a transparent display virtual touch apparatus recognizing parts of a body of a user using images captured from a camera, calculating a contact point for the transparent display worn on the body of the user, and virtually touching the contents displayed into the contact point on the display, and therefore operating interfaces of electronic appliances or obtaining contents-related information.

### BACKGROUND ART

The present invention starts on comparing touch panel technologies (operating without a cursor) with pointer technologies (having a cursor). The touch panel technologies have been widely used on electronic appliances. These touch panel technologies have an advantage of not requiring a pointer on displays comparing with the conventional pointer technologies such as a mouse on PC. That is, the users directly place their fingers onto icons without having to move a pointer (mouse cursor) to the corresponding locations using a mouse or similar point ing devices to select certain points or icons on display to perform operations. Therefore, the touch panel technologies may perform faster and more intuitive operations for controlling devices by omitting “pointer producing and moving steps” which has been required on conventional pointing technologies.

However, the touch panel technology has a disadvantage in that may not be used remotely because the user needs to physically touch the surface on a display despite the above-described convenience. Therefore, additional remote controller is needed for controlling electronic appliances away from the appliances.

Recently, a technology for remote electronic appliances controlling apparatus, like the touch panel technology, capturing a front of the display using two cameras capable of producing a pointer at correct spots and producing the pointer at a contact point on a display portion met by a line connecting eyes and fingers of the user from the captured images was disclosed in Korea unexamined patent application publication No. 2010-0129629 (published on Dec. 9, 2010).

However, there is a problem in that is difficult to exquisitely operate because the display portion for obtaining operations or information for the electronic appliances is far from the seat of the user in such prior arts.

Further, there is an inconvenience in that should perform a virtual touch operation only after surely fixing the eye line of the user to the direction of the display for the virtual touch for obtaining operations or information for the electronic appliances.

Further, there is a problem in that may not operate the electronic appliances not disposed with the display portion.

### DISCLOSURE

### Technical Problem

An advantage of some aspects of the invention is that it provides a virtual touch apparatus capable of exquisitely operating a display portion proximately worn on a face by a user.

Another advantage of some aspects of the invention is that it provides a virtual touch apparatus capable of identifying contents on a transparent display regardless of the direct ion or location of the user by using the transparent display worn on the user.

Further another advantage of some aspects of the invention is that it provides a transparent display virtual touch apparatus capable of obtaining relevant information or controlling of the electronic appliances without a display portion.

### Technical Solution

According to an aspect of the invention, there is provided a transparent display virtual touch apparatus without displaying a pointer including a transparent display portion, worn on a user's face and located in front of an eye of an user, for displaying contents on the display, a first image obtaining portion, attached to one side of the transparent display portion, for capturing a location for the eye of the user, a second image obtaining portion, attached to one side of the transparent display portion, for capturing the body of the user, and a virtual touch processing portion for detecting first space coordinates and second space coordinates using each calculated 3D coordinates data from images captured by the first image obtaining portion and the second image obtaining portion and for calculating contact point coordinates data for a display surface on the transparent display portion met by a line connecting the first space coordinates and second space coordinates.

It is preferable that the virtual touch processing portion is integrated with the transparent display portion and the first and second image obtaining portions or may be a portable terminal independent from the other components.

It is preferable that the virtual touch processing portion includes a 3D coordinates calculation portion for calculating each of the 3D coordinates data using the images captured by the first image obtaining portion and the second image obtaining portion and for extracting the first space coordinates and second space coordinates, a touch location calculation portion for calculating the contact point coordinates data for the transparent display portion met by a line connecting the first space coordinates and the second space coordinates extracted from the 3D coordinates calculation portion, and a matching processing portion for selecting contents displayed on the transparent display portion to be matched with the contact point coordinates data calculated from the touch location calculation portion and for outputting command codes performing the selected contents-related services.

It is preferable that the virtual touch processing portion uses a Time of Flight.

It is preferable that the command codes are for performing operations of certain electronic appliances or for displaying at least one of building names, lot number, shop names, ad sentences, and service sentences, for the specific goods (building) on the transparent display portion.

It is preferable that the 3D coordinates calculation portion calculates second space coordinates using the 3D coordinates extraction method based on the images for the eyes of the user captured from the first image obtaining portion, and calculates first space coordinates using the 3D coordinates extraction method based on the images for a body of the user captured from the second image obtaining portion.

It is preferable that the 3D coordinates calculation portion includes an image obtaining portion configured with at least two image sensors disposed at locations different from each other, and a space coordinates calculation portion for calculating 3D coordinates data for the body of the user using an optical triangulation scheme based on the images, captured at angles different from each other, received from the image obtaining portion.

It is preferable that the 3D coordinates calculation portion obtains the 3D coordinates data by method for projecting coded pattern images to the user and processing the images of scenes projected with the structured light.

It is preferable that the 3D coordinates calculation portion includes a lighting assembly, including alight source and a diffuser, for projecting speckle patterns to the body of the user, an image obtaining portion, including an image sensor and a lens, for capturing the speckle patterns on the body of the user projected by the lighting assembly, and a space coordinates calculation portion for calculating 3D coordinates data for the body of the user based on the speckle patterns captured from the image obtaining portion.

It is preferable that the 3D coordinates calculation portions of at least two are disposed at the locations different from each other.

It is preferable that the first space coordinates is any one of the 3D coordinates of the tip of any one of the user's fingers or the tip of the pointer grasped by the user's fingers, and the second space coordinates is the 3D coordinates for the midpoint of any one of the user's eyes.

It is preferable that the first space coordinates are the 3D coordinates for the tips of at least two of the user's fingers, and the second space coordinates is the 3D coordinates for the midpoint of any one of the user's eyes.

### Advantageous Effects

As described above, a transparent display virtual touch apparatus in the present invention has the following effects.

Firstly, the transparent display virtual touch apparatus of the present invention has a structure such as the eyes of the user-display-the fingers of the user, and therefore the user may correctly point the contents sharply displayed on the display and perform exquisite operations by locating the display in front of the eyes of the user.

Secondly, the transparent display virtual touch apparatus of the present invention locates the transparent display in front of the eyes of the user, thereby to move the transparent display while moving ahead of the user. Therefore, there is an advantage in that it is possible to always select the operations or information for the electronic appliances to look the contents displayed on the transparent display regardless of the eye line of the user.

Thirdly, the present invention may be used for the operations for the electronic appliances having no display portion. This is because the transparent display in front of the eyes of the user in the present invention may perform the same function as the display portion of the electronic appliances having no display portion. For example, the electronic appliances such as lighting appliances, refrigerators, air conditioners have no separate display portion al lowing the user look at from a distance, but such electronic appliances may be operated using the transparent display virtual touch apparatus of the present invention.

### DESCRIPTION OF DRAWINGS

FIG. 1 shows configurations of a virtual touch apparatus using a transparent display according to an exemplary embodiment of the present invention.

FIG. 2 is a block view showing the virtual touch apparatus using the transparent display according to the exemplary embodiment of the present invention.

FIG. 3 is a block diagram showing configurations of a 3D coordinates calculation portion for an optical triangulation scheme of a 3D coordinates extraction method shown in FIG. 2.

FIG. 4 is a block diagram showing the configurations of the 3D coordinates calculation portion for the structured light of the 3D coordinates extraction method shown in FIG. 2.

FIG. 5 is a flow chart for describing a virtual touch method using the transparent display according to the embodiment of the present invention.

### BEST MODE

Another purpose, characteristics and advantages of the present invention will be apparent by the detailed descriptions of the embodiments referencing the attached drawings.

The virtual touch apparatus using the transparent display is described according to the exemplary embodiment of the present invention with reference to the drawings. However, although the present invention is described by specific matters such as concrete components and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description. Therefore, the spirit of the present invention should not be limited to the above-described exemplary embodiments and the following claims as well as all modified equally or equivalently to the claims are intended to fall within the scopes and spirit of the invention.

### MODE FOR INVENTION

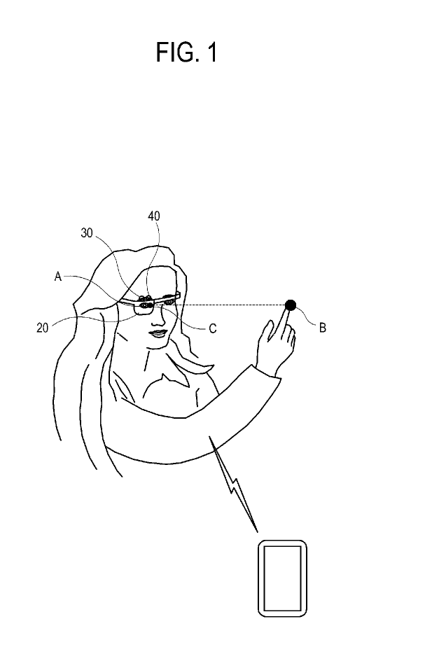

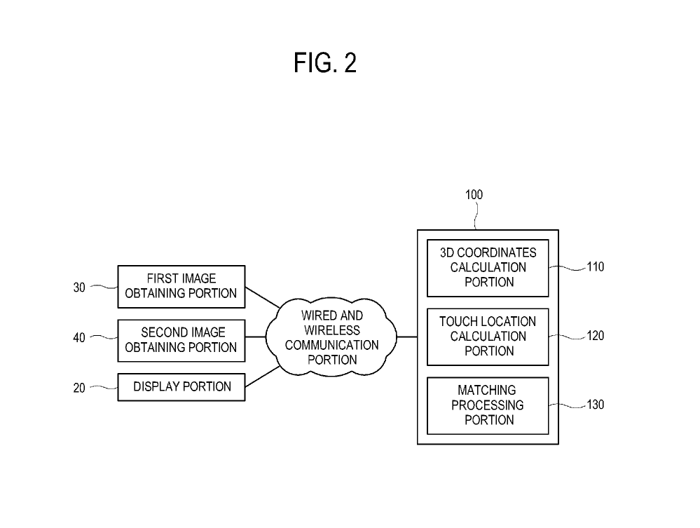

FIG. 1 shows configurations of a virtual touch apparatus using a transparent display according to an exemplary embodiment of the present invention, and FIG. 2 is a block view showing the virtual touch apparatus using the transparent display according to the exemplary embodiment of the present invention.

As shown in FIG. 1 and FIG. 2, the virtual touch apparatus includes a transparent display portion 20, worn on a user's face and located in front of an eye of the user, for displaying contents on a display, a first image obtaining portion 30, attached to one side of the transparent display portion 20, for capturing a location for eyes of the user, a second image obtaining portion 40, attached to one side of the transparent display portion 20, for capturing the body of the user, and a virtual touch processing portion 100 for detecting first space coordinates and second space coordinates using each calculated 3D coordinates data from images captured by the first image obtaining portion 30 and the second image obtaining portion 40 and for calculating contact point coordinates data for a display surface on the transparent display portion 20 met by a line connecting the first space coordinates and second space coordinates. The virtual touch processing portion 100 is integrated with the transparent display portion 20 and the first and second image obtaining portions 30, 40 or may be a portable terminal independent from the other components 20, 30 and 40.

The virtual touch processing portion 100 includes a 3D coordinates calculation portion 110 for calculating each of the 3D coordinates data using the images captured by the first image obtaining portion 30 and the second image obtaining portion 40 and for extracting the first space coordinates and second space coordinates from the calculated 3D coordinates data, a touch location calculation portion 120 for calculating the contact point coordinates data for the transparent display portion 20 met by a line connecting the first space coordinates B and second space coordinates A extracted from the 3D coordinates calculation portion 110, and a matching processing portion 130 for selecting contents displayed on the transparent display portion 20 to be matched with the contact point coordinates data calculated from the touch location calculation portion 120 and for outputting command codes performing the selected contents-related services. The contents include at least one of images, moving pictures, texts and 3D.

The command codes are for performing operations of certain electronic appliances or for displaying at least one of building names, lot number, shop names, ad sentences, and service sentences, for the specific goods (building) on the transparent display portion.

On the other hand, the command codes and various information, such as building names, lot number, shop names, ad sentences, and service sentences, for the specific goods (building) are in advance stored into a storage portion (not shown) of the virtual touch processing portion 100. Further, various information such as the building names is in advance stored into an external virtual touch apparatus and then may be transmitted through networks such as Internet.

When the user remotely performs selecting operations using the virtual touch of hands, etc., the 3D coordinates calculation portion 110 calculates second space coordinates A using the 3D coordinates extraction method based on the images for the eyes of the user captured from the first image obtaining portion 30, and calculates first space coordinates B using the 3D coordinates extraction method based on the images for a body (a finger) of the user, captured from the second image obtaining portion 40. The 3D coordinates extraction method includes an optical triangulation scheme, a structured light scheme, and a Time of Flight scheme (there are schemes duplicated from each other because correct sorting schemes are not established in relation to current 3D coordinates calculation schemes), and may be applied to any schemes or devices capable of extracting the 3D coordinates for the body of the user.

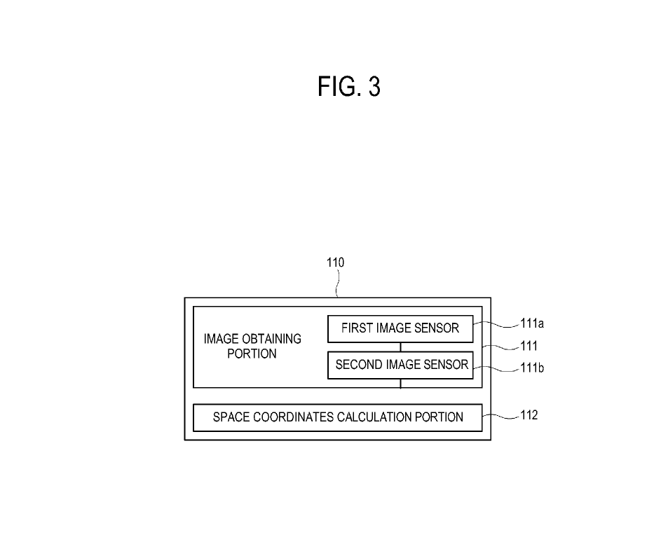

FIG. 3 is a block diagram showing configurations of a 3D coordinates calculation portion for the optical triangulation scheme of the 3D coordinates extraction method shown in FIG. 2.

As shown in FIG. 3, the 3D coordinates calculation portion 110 for the optical triangulation scheme includes an image obtaining portion 111, and a space coordinates calculation portion 112.

The image obtaining portion 111, which is a kind of a camera module, includes at least two image sensors 111a, 111b such as CCD or CMOS, disposed at positions different from each other, for detecting images and converting the detected images into electrical image signals, and captures the body of the user at angles different from each other. In addition, the space coordinates calculation portion 112 calculates the 3D coordinates data for the body of the user using the optical triangulation scheme based on the images, captured at the angles different from each other, received from the image obtaining portion 111.

The optical triangulation scheme applies the optical triangulation scheme to characterizing points corresponding between the captured images to obtain 3D information. A camera self calibration technique, a corner extraction method of Harris, a SIFT technique, a RANSAC technique, a Tsai technique, etc. are adapted to various relevant technique extracting the 3D coordinates using the triangulation scheme.

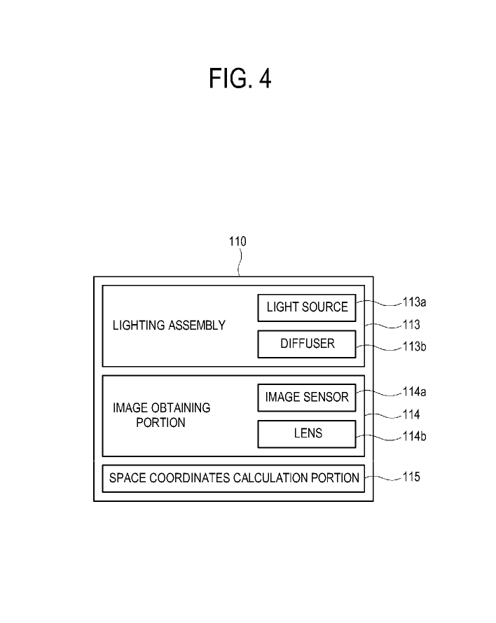

FIG. 4 is a block diagram showing configurations of a 3D coordinates calculation portion for the structured light scheme of a 3D coordinates extraction method shown in FIG. 2.

As shown in FIG. 4, the 3D coordinates calculation portion 110, for the structured light scheme, for obtaining the 3D coordinates data on projecting coded pattern images to the user and processing the images of scenes projected with the structured light includes a lighting assembly 113, including a light source 113a and a diffuser 113b, for projecting speckle patterns to the body of the user, an image obtaining portion 114, including an image sensor 114a and a lens 114b, for capturing the speckle patterns on the body of the user projected by the lighting assembly 113, and a space coordinates calculation portion 115 for calculating the 3D coordinates data for the body of the user, using the structured light scheme, based on the speckle patterns captured from the image obtaining portion 114.

Further, a 3D coordinates data calculation method using the Time of Flight (TOF) scheme may be also used as another embodiment of the present invention.

As above, the 3D coordinates data calculation methods are variously present in prior arts and may be easily implemented by those skilled in the art to which the present invention pertains, and therefore the description for them is omitted. On the other hand, patent literatures related to a method for calculating the 3D coordinates data using 2D images are Korea unexamined patent application publics No. 10-0021803, 10-2004-0004135, 10-2007-0066382 and 10-2007-0117877.

On the other hand, the touch location calculation portion 120 calculates contact point coordinates data for the transparent display portion 20 met by a line connecting the first space coordinates and the second space coordinates using the first space coordinates (a finger) and the second space coordinates (an eye) extracted from the 3D coordinates calculation portion 100.

At this time, the finger is used as the first space coordinates B. That is, the finger of a person's body is an only part capable of performing exquisite and delicate operations. In particular, an exquisite pointing may be performed on using any one of a thumb or a forefinger of fingers or together with the two fingers. Therefore, it is very effective to use trailing ends of the thumb and/or the forefinger as the first space coordinates B in the present invention. Further, in the same context, a pointer (for example, a pen tip) having a sharp tip grasped by his/her fingers may be used instead of the trailing end of his/her finger performing a role of the first space coordinates B.

In addition, a midpoint of one eye of the user is used as the second space coordinates A. For example, when the user looks the thumb in front of two eyes, the thumb will look as two. This is caused (by angle difference between both eyes) because shapes of the thumb, that both eyes of the user respectively look, are different from each other. However, if only one eye looks the thumb, the thumb will be clearly looked. In addition, although not closing one eye, the thumb will be markedly looked even on consciously looking one eye. To aim with one eye closed also follows the above principle in case of game of sports such as fire, archery, etc. requiring high accuracy on aiming.

When only one eye (the second space coordinates) looks a tip of his/her finger (the first space coordinates), the principle capable of markedly apprehending the shape of the tip of his/her finger is used in the present invention. The user should accurately look the first space coordinates B, and therefore may point the contact point coordinates data on the contents displayed on the transparent display portion 20 coincident with the first space coordinates B.

On the other hand, when one user uses anyone of his/her finger in the present invention, the first space coordinates is any one 3D coordinates of the tip of any one of the finger of the user and the tip of the pointer grasped by the finger of the user, and the second space coordinates becomes the 3D coordinates for the midpoint of any one of the user's eyes. Further, when one user uses at least two of his/her fingers, the first space coordinates allows the tip of at least two of the user's fingers to become the 3D coordinates.

In addition, the matching processing portion 130 selects the contents displayed on the transparent display portion 20 to be matched with the contact point coordinates data calculated from the touch location calculation portion 120 when the contact point coordinates data are not varied from time calculated by initial contact point coordinates data to the set time.

Further, the matching processing portion 130 determines whether the contact point coordinates data are varied from time calculated by the initial contact point coordinates data to the set time, determines whether distance variation above the set distance between the first space coordinates and second space coordinates is generated when the contact point coordinates data are not varied above the set time, and selects the contents displayed on the transparent display portion 20 to be matched with the contact point coordinates data calculated from the touch location calculation portion 120 when the distance variation above the set distance is generated.

On the other hand, when it is determined that the contact point coordinates data are varied with the set range, it may be regarded that the contact point coordinates data are not varied. That is, when the user points by the tip of his/her fingers or pointer, there are some movements or tremors of his/her body or fingers due to physical characteristics and therefore it is very difficult to maintain the contact coordinates by the user. Therefore, it is regarded that the contact point coordinates data are not varied when the contact point coordinate data values are within the predefined set range.

Operations of the virtual touch apparatus using the transparent display, according to the present invention, configured as above are described with reference to the attached drawings. Like reference numbers in FIG. 1 to FIG. 3 refer to like members performing the same functions.

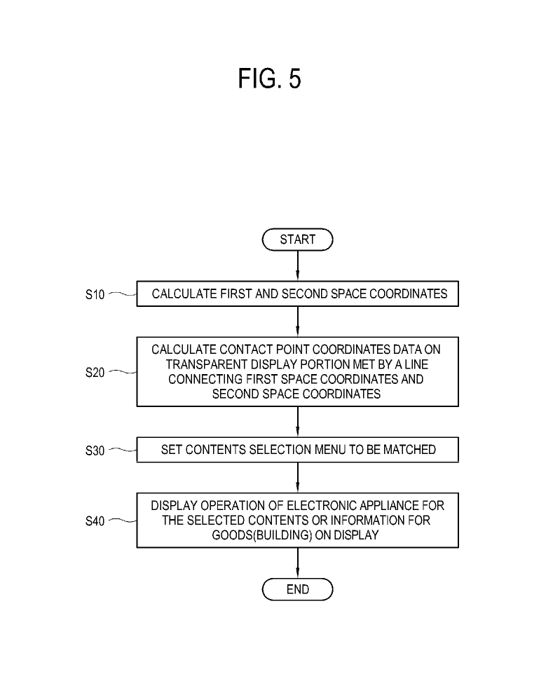

FIG. 5 is a flow chart for describing a virtual touch method using the transparent display according to the embodiment of the present invention.

Referring to FIG. 5, when the user remotely performs selection operations using the virtual touch, the 3D coordinates calculation portion 110 calculates the second space coordinates A using the 3D coordinates extraction method based on the images for eyes of the user captured from the first image obtaining portion 30, and calculates the first space coordinates B using the 3D coordinates extraction method based on the images for the body of the user captured from the second image obtaining portion 40 (S10). The 3D coordinates extraction method includes an optical triangulation scheme, a structured light scheme, and a Time of Flight scheme (there are schemes duplicated from each other because correct sorting schemes are not established in relation to current 3D coordinates calculation schemes), and may be applied to any schemes or devices capable of extracting the 3D coordinates for the body of the user.

The first space coordinates is any one 3D coordinates of the tip of any one of the user's fingers and the tip of the pointer grasped by the fingers of the user, and the second space coordinates becomes the 3D coordinates for the midpoint of any one of the user's eyes.

The touch location calculation portion 120 calculates the contact point coordinates data for the transparent display portion 20 met by a line connecting the first space coordinates B and the second space coordinates A extracted from the 3D coordinates calculation portion 110 (S20).

On the other hand, a method for calculating the contact point coordinates data for the transparent display portion 20 met by a line connecting the first space coordinates B and the second space coordinates A includes an absolute coordinates method, a relative coordinates method and an operator selection method.

The first absolute coordinates method calculates back time matching the 3D map information and the projected scenes and obtains an absolute coordinate at the space coordinates. That is, this method defines targets to be matched with camera scenes by location data having various obtainable courses such as a GPS, a gyro sensor, a compass or base station information, etc. and may obtain fast result.

The second relative coordinates method is that the camera having the absolute coordinates fixed at the space converts from the relative coordinates of the operator to the absolute coordinates. That is, this method is corresponded to a space type when the camera having the absolute coordinates reads hands and eyes, wherein one point becoming the absolute coordinates of an individual type is provided by the space type.

The third operator selection method displays the contents at the corresponding range based on obtainable information like the current smart-phone AR services, displays selection menus capable of including error ranges without a correct absolute coordinates through a selection type performed by the user and then selects them, and excludes errors by the user, thereby to obtain the result.

Next, the matching processing portion 130 selects the contents displayed on the transparent display portion 20 to be matched with the contact point coordinates data calculated from the touch location calculation portion 120 (S30). The contents displayed on the transparent display portion 20 include at least one of images, moving pictures, texts and 3D.

In addition, the matching processing portion 130 outputs the command codes for performing the selected contents-related services, operates interfaces of the electronic appliances according to the selected contents-related services or displays information for the goods (building) on the display portion 20 by the outputted command codes (S40). The contents-related services may include menus for information such as building names, lot numbers, shop names, ad sentences and service sentences for the building or location or the description for works such as works of art or collections or may include operation menus for operating the interfaces of the specific electronic appliances by the 3D map information.

Although the present invention has been shown and described with the exemplary embodiment as described above, the present invention is not limited to the exemplary embodiment as described above, but may be variously changed and modified by those skilled in the art to which the present invention pertains without departing from the scope of the present invention. Accordingly, the actual technical protection scope of the present invention must be determined by the spirit of the appended claims.

### INDUSTRIAL APPLICABILITY

The virtual touch apparatus of the present invention recognizes a part of the body of the user using the images captured from the camera, calculates the contact point with the transparent display worn on the body of the user, virtually touches the contents displayed into the contact point on the display, and operates the interfaces of the electronic appliances.

1. A transparent display virtual touch apparatus without displaying a pointer, comprising:
a transparent display portion, configured to be worn on a user's face and located in front of an eye of a user, for displaying contents on a display;
a first image obtaining portion, attached to one side of the transparent display portion, for capturing a location for the eye of the user;
a second image obtaining portion, attached to one side of the transparent display portion, for capturing the body of the user; and
a virtual touch processing portion for detecting first space coordinates and second space coordinates using each calculated 3D coordinates data from the images captured by the first image obtaining portion and the second image obtaining portion and for calculating contact point coordinates data that a line connecting the first space coordinates and the second space coordinates meets a display surface on the transparent display portion.

2. The transparent display virtual touch apparatus without displaying a pointer according to claim 1, wherein the virtual touch processing portion is integrated with the transparent display portion and the first and second image obtaining portions or is an portable terminal independent from the other components.

3. The transparent display virtual touch apparatus without displaying a pointer according to claim 1, wherein the virtual touch processing portion includes a 3D coordinates calculation portion for calculating each of the 3D coordinates data using the images captured by the first image obtaining portion and the second image obtaining portion and for extracting the first space coordinates and the second space coordinates, a touch location calculation portion for calculating the contact point coordinates data that a line connecting the first space coordinates and the second space coordinates extracted from the 3D coordinates calculation portion meets the transparent display portion, and a matching processing portion for selecting contents displayed on the transparent display portion to be matched with the contact point coordinates data calculated from the touch location calculation portion and for outputting command codes performing the selected contents-related services.

4. The transparent display virtual touch apparatus without displaying a pointer according to claim 1, wherein the virtual touch processing portion uses a Time of Flight.

5. The transparent display virtual touch apparatus without displaying a pointer according to claim 3, wherein the command codes are for performing operations of certain electronic appliances or for displaying at least one of building names, lot number, shop names, ad sentences, and service sentences, for the specific goods (building) on the transparent display portion.

6. The transparent display virtual touch apparatus without displaying a pointer according to claim 3, wherein the 3D coordinates calculation portion calculates second space coordinates using the 3D coordinates extraction method based on the images for the eyes of the user captured from the first image obtaining portion, and calculates the first space coordinates using the 3D coordinates extraction method based on the images for a body of the user captured from the second image obtaining portion.

7. The transparent display virtual touch apparatus without displaying a pointer according to claim 6, wherein the 3D coordinates calculation portion includes an image obtaining portion configured with at least two image sensors disposed at locations different from each other, and a space coordinates calculation portion for calculating 3D coordinates data for the body of the user using the optical triangulation scheme based on the images, captured at angles different from each other, received from the image obtaining portion.

8. The transparent display virtual touch apparatus without displaying a pointer according to claim 6, wherein the 3D coordinates calculation portion obtains the 3D coordinates data by method for projecting coded pattern images to the user and processing the images of scenes projected with the structured light.

9. The transparent display virtual touch apparatus without displaying a pointer according to claim 8, wherein the 3D coordinates calculation portion includes a lighting assembly, including a light source and a diffuser, for projecting speckle patterns to the body of the user, an image obtaining portion, including an image sensor and a lens, for capturing the speckle patterns on the body of the user projected by the lighting assembly, and a space coordinates calculation portion for calculating 3D coordinates data for the body of the user based on the speckle patterns captured from the image obtaining portion.

10. The transparent display virtual touch apparatus without displaying the pointer according to claim 8, wherein the 3D coordinates calculation portions of are at least two or more and are configured to be disposed at the locations different from each other.

11. The transparent display virtual touch apparatus without displaying a pointer according to claim 1 or claim 3, wherein the first space coordinates is any one of the 3D coordinates of the tip of any one of the user's fingers or the tip of the pointer grasped by the user's fingers and the second space coordinates becomes the 3D coordinates for the midpoint of any one of the user's eyes.

12. The transparent display virtual touch apparatus without displaying the pointer according to claim 1 or claim 3, wherein the first space coordinates are the 3D coordinates for the tips of at least two of the user's fingers, and the second space coordinates is the 3D coordinates for the midpoint of any one of the user's eyes.

13. The transparent display virtual touch apparatus without displaying a pointer according to claim 3, wherein the first space coordinates is any one of the 3D coordinates of the tip of any one of the user's fingers or the tip of the pointer grasped by the user's fingers and the second space coordinates becomes the 3D coordinates for the midpoint of any one of the user's eyes.

14. The transparent display virtual touch apparatus without displaying the pointer according to claim 3, wherein the first space coordinates are the 3D coordinates for the tips of at least two of the user's fingers, and the second space coordinates is the 3D coordinates for the midpoint of any one of the user's eyes.
